(19) United States
(12) Patent Application Publication
(10) Pub. No.: US 2008/0126983 A1
(43) Pub. Date: May 29, 2008

(54) CONTENT-BASED ORDERING OF A LIST OF SELECTABLE ENTRIES FOR AN AUTO-COMPLETE BOX

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: IBM CORP (AP);C/O AMY PATTILLO, P. O. BOX 161327, AUSTIN, TX, 78716, US

(21) Appl. No.: 11/564,330

(22) Filed: Nov. 29, 2006

(51) Int. Cl. G06F 3/048

(52) U.S. Cl. 715/810

(57) ABSTRACT

An auto-complete controller monitors a window including an auto-complete box for at least one content element of the window. Responsive to detecting the user selection to fill in the auto-complete box, the auto-complete controller accesses a list of selectable entries for filling in the auto-complete box. In addition, the auto-complete controller accesses at least one rule specifying order of the list of selectable entries based on a detected content element. The auto-complete controller reorders the list of selectable entries for output in association with the auto-complete box with a most likely candidate listed first based on the rule specifying order of the list of selectable entries based on the detected content element.

### TECHNICAL FIELD

The present invention relates in general to an improved auto-complete box. In particular, the present invention relates to ordering a list of selectable entries for an auto-complete box based on the content of a window including the auto-complete box.

### DESCRIPTION OF THE RELATED ART

For a user to interact with a network, whether requesting access to a particular website or file system or requesting to send an electronic message to another user, a user is typically required to enter a network address. As the number of network addresses accessible to or used by a user increases, it may be difficult for the user to remember these addresses. Thus, address books, bookmarking tools, and other organizational tools have been developed which monitor network addresses accessed by or entered by a user and store these network addresses for later selection by the user.

In addition, in an effort to aid a user in more efficient entry of network addresses, another feature of many network applications is an auto-complete box. For many auto-complete boxes, as a user begins to enter characters in the box, a list of network addresses previously entered by or accessed by the user is filtered such that those addresses which include the combination of letters entered by the user are presented to the user in a selectable list or automatic completion of the address with one or more of the filtered addresses.

While auto-complete boxes and the list associated with auto-complete boxes make address selection more efficient for a user, the selectable list of addresses presented to the user may still require the user to search through a large list of addresses to find the address that the user is looking for. For example, if a user enters “ch” in the auto-complete box of an electronic message composition window, the user could be presented with multiple addresses starting with “ch” or including the letter combination of “ch”, where the user would still have to scroll through the list of addresses with “ch” to identify the desired address.

In addition to auto-complete boxes for network addresses, windows may include auto-complete boxes for selecting from other types of entries. For example, a window may include an auto-complete box for a user to type in a particular style name or select from a list of styles. Regardless of the type of auto-complete box, current lists associated with auto-complete boxes are limited because lists of potential entries are ordered independent from the content of the window including the auto-complete boxes.

Therefore, in view of the foregoing, there is a need for a method, system, and program for ordering potential entries for an auto-complete box within a window based on the contents of the window.

### SUMMARY OF THE INVENTION

Therefore, the present invention provides improved ordering of lists associated with auto-complete boxes. In particular, the present invention provides for ordering a selectable list of potential entries for an auto-complete box based on the content of a window including the auto-complete box.

In one embodiment, an auto-complete controller monitors a window including an auto-complete box for at least one content element of the window. Responsive to detecting the user selection to fill in the auto-complete box, the auto-complete controller accesses a list of selectable entries for filling in the auto-complete box. In addition, the auto-complete controller accesses at least one rule specifying order of the list of selectable entries based on a detected content element. The auto-complete controller reorders the list of selectable entries for output in association with the auto-complete box with a most likely candidate listed first based on the rule specifying order of the list of selectable entries based on the detected content element.

Monitoring the window includes monitoring an electronic composition window comprising the auto-complete box for filling in at least one network address for at least one addressee of an electronic message composed within the electronic message composition window for a content element of the electronic message. In addition, monitoring the window includes monitoring a browser window comprising an auto-complete box for selecting a next website address for access for at least one content element of a current website displayed within the browser window. Further, monitoring the window includes monitoring a composition window comprising an auto-complete box for selecting a style for at least one selection of a document composed within the window for at least one content element of the document composed within the composition window.

The content element includes a window that includes one of a reply message, a new message, or a forwarded message. In addition, the content element includes a type of attachment to a document composed within the window. Further, the content element includes one addressee already specified for receiving an electronic message composed within the window.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram illustrating one example a network environment for supporting network based communication in which the present invention may be implemented;

FIG. 2 is a block diagram depicting one embodiment of a computer system in which the present invention may be implemented;

FIG. 3 is a block diagram illustrating one embodiment of components of an auto-complete controller;

FIG. 4 is an illustrative diagram depicting one embodiment of a user interface through which a user may adjust ordering preferences and select from among predicted rules;

FIG. 5 is an illustrative diagram illustrating a user interface in which a list of selectable addresses for an auto-complete box is reordered based on the content of a message composition window including the auto-complete box;

FIG. 6 is an illustrative diagram depicting a user interface in which a list of selectable websites for an auto-complete box is reordered based on the content of the current website being viewed in a browser window that includes the auto-complete box;

FIG. 7 is a high level logic flowchart illustrating a process and program for selecting a list of selectable entries for an auto-complete box and reordering the list of selectable entries based on the content of a window including the auto-complete box;

FIG. 8 is a high level logic flowchart depicting a process and program for controlling the reordering a list of selectable entries determined for an auto-complete box; and

FIG. 9 is a high level logic flowchart illustrating a process and program for monitoring potential entries for auto-complete boxes; and

FIG. 10 is a high level logic flowchart depicting a process and program for controlling a user interface for user preference selection of rules for an auto-complete controller.

### DETAILED DESCRIPTION OF THE PREFERRED EMBODIMENT

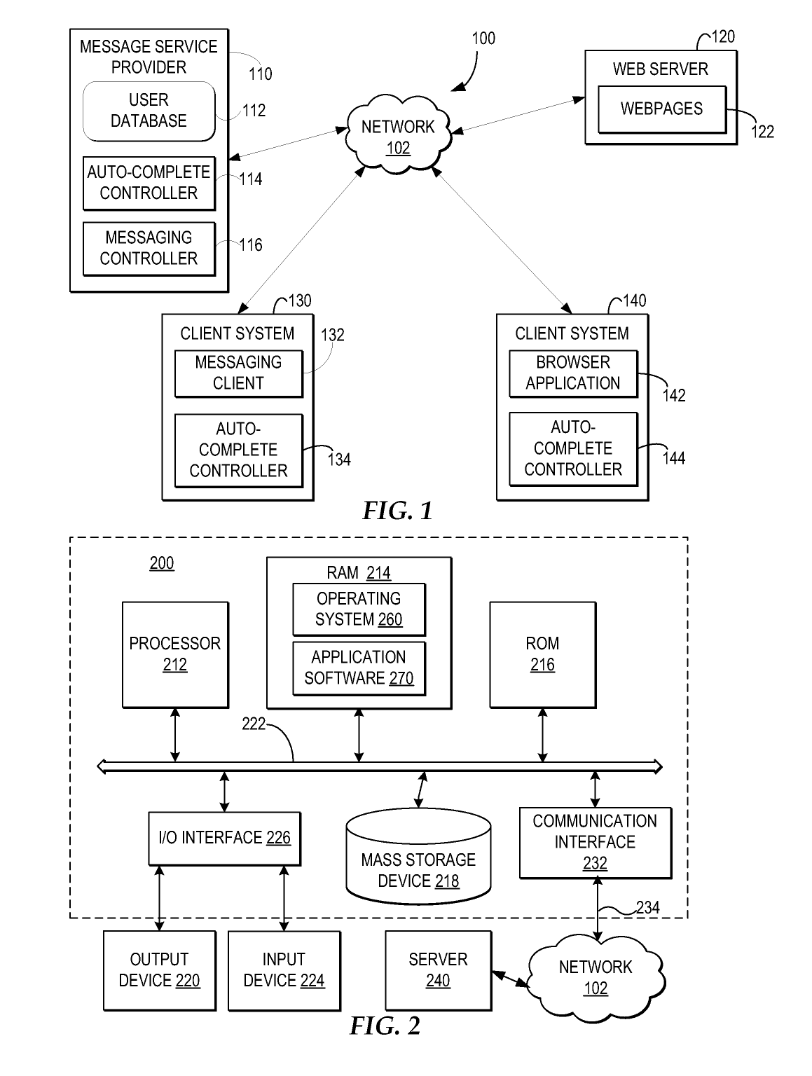

With reference now to FIG. 1, a block diagram illustrates one example a network environment for supporting network based communication in which the present invention may be implemented. It is important to note that network environment 100 is illustrative of one type of network environment in which network based communication may be supported, however, the network based communication method, system, and program may be implemented in other network environments. In addition, it is important to note that the distribution of systems within network environment 100 is illustrative of a distribution of systems; however, other distributions of systems within a network environment may be implemented.

As illustrated, multiple systems within network environment 100 may be communicatively connected via network 102, which is the medium used to provide communications links between various devices and computer communicatively connected. Network 102 may include permanent connections such as wire or fiber optics cables and temporary connections made through telephone connections and wireless transmission connections, for example. Network 102 may represent both packet-switching based and telephony based networks, local area and wide area networks, public and private networks. It will be understood that FIG. 1 is representative of one example of a distributed communication network for supporting electronic message accessibility; however other network configurations and network components may be implemented for supporting and implementing electronic message accessibility in the present invention. Additionally, network environment 100 supports multiple types and levels of communication protocols for facilitating composition, distribution, and viewing of multiple types of electronic message communications.

Network environment 100 may implement multiple types of network architectures. In one example, network environment 100 may be implemented using a client/server architecture, where computing systems requesting data or processes are referred to as clients and computing systems processing data requests and processes are referred to as servers. In another example, network environment 100 may be implemented in a peer-to-peer network architecture. It will be understood that other types of network architectures and combinations of network architectures may be implemented.

In the embodiment, as illustrated, a message service provider 110 is communicatively connected to one or more other message service provider systems and client systems, such as client systems 130 and client system 140, via network 102. Message service provider 110 provides a messaging service to one or more users. In one example, message service provider 110 provides messaging service through messaging controller 116 to one or more users for receiving electronic messages addressed to the user, for receiving electronic messages composed by the user, for delivering electronic messages to the user and for delivering electronic messages composed by the user to an addressee. User database 112 of message service providers 110 maintains user registration information, user preferences, user history, and messages sent by and received by the user. In addition, user database 112 may maintain address books and other data management services for users. Electronic messages may include, but are not limited to, electronic mail messages, instant messages, text messages, video messages, and other types of communications transmittable over network 102 between two or more systems. Message service provider 110 may communicatively connect with one or more other message service providers to enable a messaging session and to facilitate the delivery of electronic messages between a service user and at least one other user specified to receive an electronic message.

In one example, a user logs in to message service provider 110 at client system 130 through a messaging client 132. In one embodiment, messaging client 132 is a browser application through which a user requests access to a messaging website of message service provider 110 and logs on through the website to message service provider 110. Within the website interface facilitated within a browser window of messaging client 132, a user composes an electronic message. In another embodiment, messaging client 132 is a client based messaging application, where the client based messaging application logs on to message service provider 110 and provides a client-side interface for a user to compose a message.

According to an advantage, messaging service provider 110 or messaging client 132 may implement an auto-complete controller, such as auto-complete controller 114 of message service provider 110 or auto-complete controller 134 of client system 130. Auto-complete controllers 114 and 134 monitor an electronic message composition window, whether facilitated by message service provider 110 or messaging client 132 and control the reordering of a list of selectable addresses for an auto-complete box within the electronic message composition window, where the reordering is based on the content of the composed electronic message within the electronic message composition window. In addition, other non-content based characteristics, such as a current time or the most recently used address, may be the basis for reordering the list of selectable addresses.

In one example, where auto-complete controller 114 is implemented by message service provider 110, user database 112 may include, for each user, a selection of content-based rules for auto-complete controller 114 to follow in reordering a list of selectable addresses. In another example, where auto-complete controller 134 is implemented at client system 130, selections of rules for a user are stored locally at client system 130 and selected based on the currently selected user account. In one example, a single user may use multiple messaging accounts, where each account is identified by a different network address. The user may select for messaging client 132 to support each of the different messaging accounts, where the user may quickly change from one account to the next by selecting from a list of accounts, and for auto-complete controller 134 to implement a different set of content-based rules for each of the different messaging accounts.

In the embodiment, network environment 100 includes a web server 120 for facilitating access by other systems to one or more web pages 122 each associated with or assigned to a particular network address. It will be understood that network environment 100 may include additional or alternate web servers and that any system communicatively connected via network 102 may facilitate access to websites.

Network environment 100 also includes client system 140, which includes a browser application 142. Browser application 142 controls connections to web servers via network 102 to access website data and controls a display interface for the accessed website data. In particular, a user selects a website address for a website within a browser window of browser application 142 and browser application 142 locates a web server identified by the address, such as web server 120, and requests access to the data located at the address.

According to an advantage, browser application 142 may implement an auto-complete controller, such as auto-complete controller 144. Auto-complete controller 144 monitors a browser window facilitated by browser application 142 and controls the reordering of a list of selectable website addresses for an auto-complete box within the browser window, where the reordering is based on a content characteristic of the website currently accessed within the browser window.

As described, auto-complete controllers, such as auto-complete controllers 134 and 144 may monitor content within an electronic message composition window or browser window and control the reordering of a list of selectable network addresses for one or more auto-complete boxes within the monitored window. In addition, auto-complete controllers, such as auto-complete controllers 134 and 144 may control the reordering of other types of lists of entries for other types of auto-complete boxes within electronic message composition windows and browser windows. Further, auto-complete controllers, such as auto-complete controllers 134 and 144 may monitor content within other types of application windows and control reordering of lists of other types of selectable entries for auto-complete boxes within the other types of application windows. For example, within an electronic message composition window or other type of composition window, such as a word processor window, a user may select from styles to apply to the text within the composition window. Auto-complete controllers 134 and 144 may monitor the current content for a composition window and selectively reorder a list of selectable style options for an auto-complete box based on the current content of the composition window.

As described herein, the term “content” may include both the displayed and non-displayed portions of content of a document, website, electronic message or other data opened in a monitored window. In addition “content” may include, but is not limited to, text, graphics, video, audio, and other types of data. It will be understood that “content” may include any detectable item associated within a monitored window.

In addition, as described herein, the term “auto-complete box” may include a displayable box which the user triggers to auto-complete by selecting the box or entering text or other data into the box. In addition, “auto-complete box” may include other selectable options, the selection of which triggers the output of multiple selectable options. It will be understood that an “auto-complete box” is not limited to a graphical box, but may be implemented through multiple types of selectable output elements.

A list of selectable entries includes the potential entries for a particular type of auto-complete box. A list of selectable entries may include the actual entry and aliases or other identifiers for an entry. For example, for filling in a network address, an entry may include a network address for an individual, such as “sally@us.ibm.com” and an alias for the network address, such as “Sally Smith.”

Referring now to FIG. 2, a block diagram illustrates one embodiment of a computer system in which the present invention may be implemented. The controllers and systems of the present invention may be executed in a variety of systems, including a variety of computing systems, such as computer system 200, communicatively connected to a network, such as network 202.

Computer system 200 includes a bus 222 or other communication device for communicating information within computer system 200, and at least one processing device such as processor 212, coupled to bus 222 for processing information. Bus 222 preferably includes low-latency and higher latency paths that are connected by bridges and adapters and controlled within computer system 200 by multiple bus controllers. When implemented as a server, computer system 200 may include multiple processors designed to improve network servicing power. Where multiple processors share bus 222, an additional controller (not depicted) for managing bus access and locks may be implemented.

Processor 212 may be a general-purpose processor such as IBM's PowerPC™ processor that, during normal operation, processes data under the control of an operating system 260, application software 270, middleware (not depicted), and other code accessible from a dynamic storage device such as random access memory (RAM) 214, a static storage device such as Read Only Memory (ROM) 216, a data storage device, such as mass storage device 218, or other data storage medium.

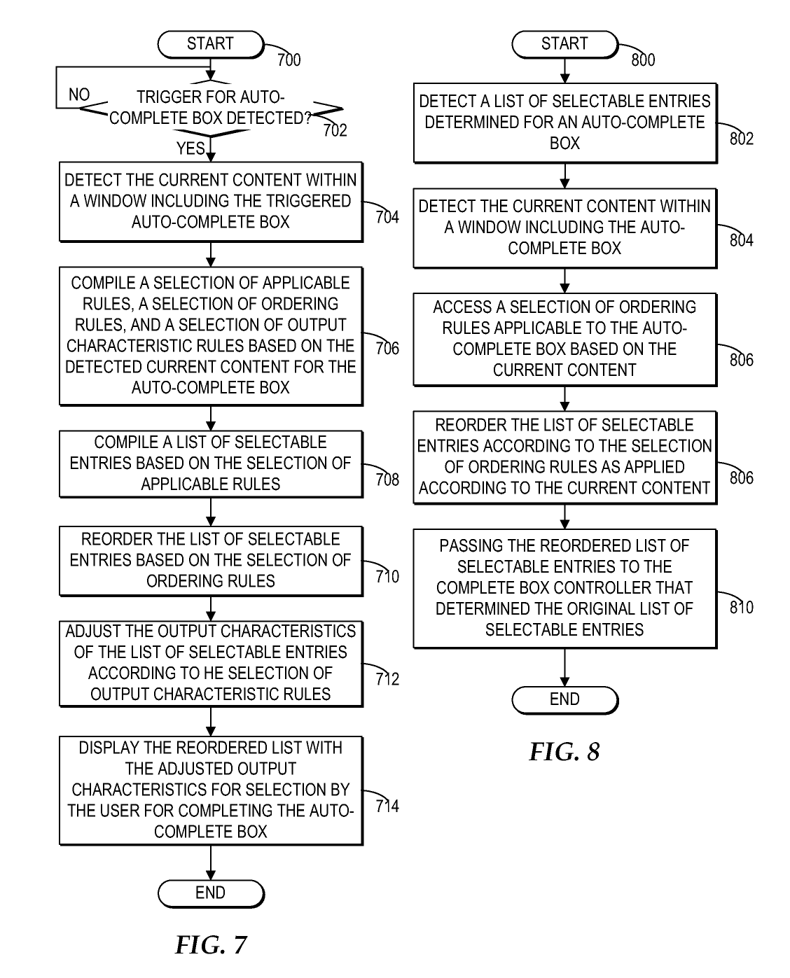

In one embodiment, the operations performed by processor 212 may control ordering a list of selectable entries for an auto-complete box according to the content of the window including the auto-complete box, monitoring user activity to set rules for ordering selectable entries based on content, and enabling a user to set preferences as to rules for ordering selectable entries based on content, as depicted in the operations of flowcharts of FIGS. 7-10 and other operations described herein. Operations performed by processor 212 may be requested by operating system 260, application software 270, middleware or other code or the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 200 to perform a process according to the present invention. The term “machine-readable medium” as used herein includes any medium that participates in providing instructions to processor 212 or other components of computer system 200 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 200 can read and which is suitable for storing instructions. In the present embodiment, an example of a non-volatile medium is mass storage device 218 which as depicted is an internal component of computer system 200, but will be understood to also be provided by an external device. Volatile media include dynamic memory such as RAM 214. Transmission media include coaxial cables, copper wire or fiber optics, including the wires that comprise bus 222. Transmission media can also take the form of acoustic or light waves, such as those generated during radio frequency or infrared data communications.

Moreover, the present invention may be downloaded or distributed as a computer program product, wherein the program instructions may be transferred from a remote computer such as a server 240 to requesting computer system 200 by way of data signals embodied in a carrier wave or other propagation medium via network 202 to a network link 234 (e.g. a modem or network connection) to a communications interface 232 coupled to bus 222. In one example, where processor 212 includes multiple processor elements is, a processing task distributed among the processor elements, whether locally or via a network, may represent a consumer program product, where the processing task includes program instructions for performing a process or program instructions for accessing Java (Java is a registered trademark of Sun Microsystems, Inc.) objects or other executables for performing a process. Communications interface 232 provides a two-way data communications coupling to network link 234 that may be connected, for example, to a local area network (LAN), wide area network (WAN), or directly to an Internet Service Provider (ISP). In particular, network link 234 may provide wired and/or wireless network communications to one or more networks, such as network 202. Further, although not depicted, communication interface 232 may include software, such as device drivers, hardware, such as adapters, and other controllers that enable communication. When implemented as a server, computer system 200 may include multiple communication interfaces accessible via multiple peripheral component interconnect (PCI) bus bridges connected to an input/output controller, for example. In this manner, computer system 200 allows connections to multiple clients via multiple separate ports and each port may also support multiple connections to multiple clients.

Network link 234 and network 202 both use electrical, electromagnetic, or optical signals that carry digital data streams. The signals through the various networks and the signals on network link 234 and through communication interface 232, which carry the digital data to and from computer system 500, may be forms of carrier waves transporting the information.

In addition, computer system 200 may include multiple peripheral components that facilitate input and output. These peripheral components are connected to multiple controllers, adapters, and expansion slots, such as input/output (I/O) interface 226, coupled to one of the multiple levels of bus 222. For example, input device 224 may include, for example, a microphone, a video capture device, a card reader, a body scanning system, a keyboard, a mouse, or other input peripheral device, communicatively enabled on bus 222 via I/O interface 226 controlling inputs. In addition, for example, an output device 220 communicatively enabled on bus 222 via I/O interface 226 for controlling outputs may include, for example, one or more graphical display devices, audio speakers, and tactile detectable output interfaces, but may also include other output interfaces. In alternate embodiments of the present invention, additional or alternate input and output peripheral components may be added.

Those of ordinary skill in the art will appreciate that the hardware depicted in FIG. 2 may vary. Furthermore, those of ordinary skill in the art will appreciate that the depicted example is not meant to imply architectural limitations with respect to the present invention.

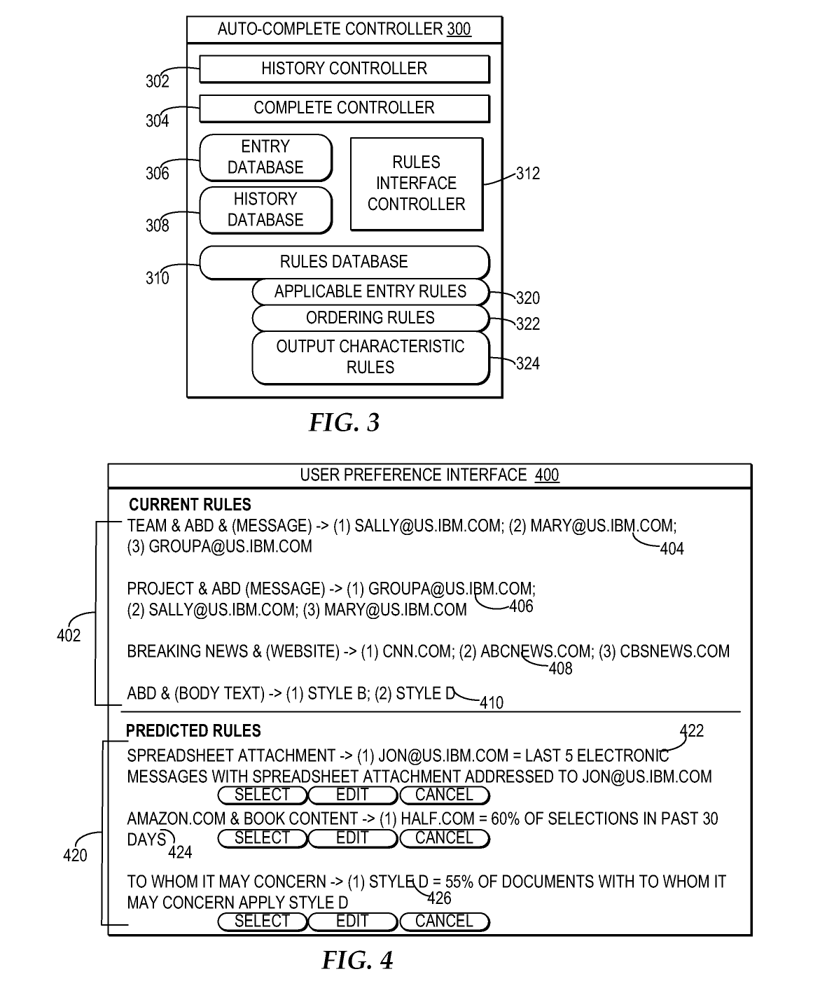

With reference now to FIG. 3, a block diagram depicts one embodiment of components of an auto-complete controller. In the example, an auto-complete controller 300 may control the reordering of a list of selectable entries for an auto-complete box within one or more types of application windows. It will be understood that additional or alternate components and data structures from those depicted within auto-complete controller 300 may be implemented. In addition, it will be understood that the data structures described in association with auto-complete controller 300 may be implemented through one or more data storage systems and structures or one or more varying types of data storage systems and structures.

In the example, auto-complete controller 300 includes a history controller 302. History controller 302 controls the collection of potential entries for an auto-complete box in an entry database 306 and monitors user interaction with the collection of potential entries and content associated with the collected entries and stores the monitored interaction and content in a history database 308.

For example, within a messaging composition interface context, history controller 302 monitors incoming and outgoing electronic messages for any addresses included in the electronic messages and stores the addresses in entries database 306. In addition, history controller 302 collects one or more types of content within each electronic message and stores addresses and associated message content together in history database 308.

In another example, within a browser application content, history controller 302 monitors user selected website addresses and website addresses included within an accessed website and stored the collected website addresses in entries database 306. In addition, history controller 302 collects one or more types of content within each website and monitors the progression of websites accessed in succession and stores the website content and user interaction information in history database 308.

In yet another example, within a composition interface, history controller 302 monitors uses selected styles for a window and stores the styles in entries database 306. In addition, history controller 302 monitors the content of a composition window associated with the use of a style and stores the style and composition window content correlations in history database 308.

In addition, it is important to note that history controller 302 may monitor for entries across multiple applications. For example, history controller 302 may monitor for styles created by and applied by a user using a word processing application and using an electronic messaging client application. In another example, history controller 302 may monitor for websites identified in a browser window and for websites identified in a document opened in a word processing application.

Further, it is important to note that entries database 306 may include entries collected by history controller 302 and entries collected in varying entry storage structures. In one example, entries database 306 may include or access entries from an electronic address book of personal network addresses for electronic messaging and server addresses for websites, where the electronic address book may be maintained by an electronic address book application or by a messaging client or messaging server. In another example, entries database 306 may include or access entries of website addresses from a bookmark directory maintained by a browser application or by a website bookmarking service accessible over network 102. In yet another example, entries database 306 may include or access a style directory of graphical output styles created by a user or generated by another application.

Based on the user interaction and content correlations to entries stored in history database 308, history controller 302 may predict applicable rules for controlling the reordering of lists of selectable entries for an auto-complete box for a particular user. In predicted applicable rules, history controller 302 may consider factors including, but not limited to, the frequency of association of content with an entry, whether the entry is entered by the user or detected within a document, electronic message, or website, the frequency of a particular word or phrase in comparison with similar words or phrases, the times at which a particular type of content or entry is detected, and the frequency of attachments associated with an entry. Factors considered by history controller 302 may vary based on the type of entry and the type of interface window in which the entry is detected.

In one example of predicting rules, where history database 308 includes one or more records of a user addressing an electronic message to “sally@us.ibm.com” with subject line of the electronic message including “fwd” and “cnn”, then history controller 302 will predict a rule that when “fwd” and “cnn” are detected in the subject line of an electronic message, then the address “sally@us.ibm.com” should be ordered at the top of a list of selectable entries for the “to:” address auto-complete box within the electronic message composition window. In another example, where history database 308 includes one or more records of a user selecting the following news sites in succession: “cnn.com”, “drudgereport.com”, “abcnews.com”, then history controller 302 will predict a rule that when “cnn.com” is accessed in a browser window, then the website addresses “drudgereport.com” and “abcnews.com” should be ordered at the top of a list of selectable entries for the address auto-complete box within the browser window. In yet another example, where history database includes one or more records of a user selecting a “style C” when the content of a composition window includes a frequent use of the phrase “project ACD”, then history controller 302 will predict a rule that when a composition window includes a frequent use of the phrase “project ACD”, then “style C” should be ordered at the top of a list of selectable entries for a style auto-complete box within the composition window.

In particular, in detecting content, history controller 302 may detect differences in content, such as the difference in the addressees associated with each of the phrases “project ACD” and “the team for project ACD”. In another example, history controller 302 may monitor differences in addressees associated with the phrase “project ACD” within the subject line of an electronic messages and the same phrase “project ACD” within the body of the electronic message. It is important to note that other types of differences in content and the entries associated with the differences in content may be detected and compiled.

A rules interface controller 312 provides an interface through which a user may select rules for controlling which entries to include in a list of entries for an auto-complete box, the ordering of the entries within the auto-complete box, and any other preferences for specializing the output of the list of entries for an auto-complete box for the user. In one example, when a user selects to update rule preferences, rules interface controller 312 triggers a display interface for displaying the user's currently selected rule preferences and for displaying the rules predicted by history controller 302. A user may select to adjust the current rules and may select to add one or more of the predicted rules to rules 310. In another example, when history controller 302 detects a change in user behavior in association with a rule or predicts a new rule, history controller 302 may trigger rules interface controller 312 to prompt the user to adjust a rule or adopt a new rule.

As illustrated, rules 310 includes one or more types of rules, including, but not limited to, applicable entry rules 320, ordering rules 322, and output characteristic rules 324. In addition, rules 310 may include additional or alternate types of rules within rules 310.

Applicable entry rules 320 specify rules for selecting those entries that are applicable for an auto-complete box from among entry database 306. Applicable entry rules 320 may include rules that apply independent of the content of a window and rules that apply based on the content of a window. In addition, applicable entry rules 320 may include rules that adjust the applicable entries for an auto-complete box based on the text entered into the auto-complete box.

Ordering rules 322 specify rules for ordering the list of applicable entries for an auto-complete box. Ordering rules 322 may include rules that apply independent of the content of a window, such as a most recently used prioritization, and rules that apply based on the content of a window. Ordering rules 322 may also include rules for prioritizing applicable rules when multiple ordering rules apply.

Output characteristic rules 320 specify rules for controlling the output characteristics of the list of ordered, applicable entries. For example, output characteristic rules 320 may specify that when reordering of a list is performed, the top ten percent of entries with the highest priority according to ordering rules 322 are colored green, the next fifty percent of prioritized entries are colored yellow, and the remainder of entries are colored red. In another example, output characteristic rules 320 may specify a rule that once the list of entries is ordered according to content based ordering rules, a graphical attribute further illustrates a non-content based ordering rule, such as most recent use.

Auto-complete controller 300 includes a complete controller 304. Complete controller 304 detects a trigger to complete an auto-complete box and detects the content characteristics of a window including the auto-complete box. Next, complete controller 304 determines, from entry database 306 and applicable entry rules 320, a selection of the entries to include in a list of entries for the auto-complete box. In addition, complete controller 304 determines which rules from among ordering rules 322, apply for the auto-complete box based on content and non-content characteristics. Based on the applicable ordering rules, complete controller 304 reorders the list of entries for the auto-complete box and may also add additional entries. Additionally, complete controller 304 may apply output characteristic rules 320 and provide the user with the list of ordered entries within the type of interface programmed for the auto-complete box.

It is important to note that while complete controller 304 is described as compiling the list of entries for an auto-complete box, in one embodiment, complete controller 304 may plug-in to an existing controller that determines the list of entries, such that complete controller 304 only reorders the list of entries determined by the existing controller. For example, auto-complete controller 300, and in particular complete controller 304 may plug-in to or access the auto-complete function of a messaging client, access the list of entries generated by the auto-complete function of the messaging client, reorder the list of entries, and return the generated list of entries to auto-complete function of the messaging client.

Referring now to FIG. 4, an illustrative diagram depicts one embodiment of a user interface through which a user may adjust ordering preferences and select from among predicted rules. In the example, a user interface 400 includes a selection of current rules 402 and predicted rules 420.

For purposes of example, examples of rules are illustrated at reference numerals 404 and 406 for content including the combination of letters “ABD”. In one example, for an electronic message in which “team” and “ABD” is detected in the subject line of the electronic message, priority is given to the following electronic addresses as first “sally@us.ibm.com”, second “mary@us.ibm.com”, and third “groupA@us.ibm.com” and for an electronic message in which “project” and “ABD” are detected in the subject line or body of an electronic message, priority is given to the following electronic addresses as first “groupA@us.ibm.com”, second “sally@us.ibm.com”, and third “mary@us.ibm.com”. Additional content designations may vary based on whether there is an attachment to an electronic message, whether the currently composed electronic message is a new message, a reply to an electronic message, a reply to all of an electronic message, or a forward of an electronic message.

In addition, for purposes of example, an example of a rule is illustrated at reference numeral 408 for a website when “breaking news” is detected within the content of a website currently displayed. In the example, when the current website includes the phrase “breaking news”, priority is given to the following website addresses as first “cnn.com”, second “abcnews.com”, and third “cbsnews.com”.

In addition, for purposes of example, an example of a rule is illustrated at reference numeral 410 for a website when “ABD” is detected within the body of the text in a window. In the example, when “ABD is detected within the body of the text in a window, priority is given to the following styles as first “style B” and second “style D”, where each of “style B” and “style D” represent different formatting combinations.

As illustrated for predicted rules 420, multiple predicted rules may be illustrated for different types of entries, with a selectable option with each predicted rule to add the rule, cancel the rule, or adjust the rule. For example, as illustrated at reference numeral 422, a predicted rule specifies that if a spreadsheet document attachment is detected as attached to an electronic message, then an address “jon@us.ibm.com” be prioritized as the first entry in a list of address entries, based on the tracked history of the last five electronic messages included a spreadsheet document attachment also being addressed to “jon@us.ibm.com.” In another example, as illustrated at reference numeral 424, a predicted rule specifies that when a user is viewing a first shopping website “amazon.com” and the content of the pages viewed by the user includes book selections, then based on the tracked history the user is most likely to next select to view the website “half.com” to compare prices of books and therefore the website “half.com” should be prioritized as the first entry in a list of address entries when the user is viewing the website “amazon.com” and books. In yet another example, as illustrated at reference numeral 426, a predicted rule specifies that when a user composes a document or message that includes a salutation of “To whom it may concern” then a “style D” be prioritized as the first entry in a list of style entries, based on the tracked history of the user selecting a style represented by “style D” over half of the times that the salutation of “To whom it may concern” appears in a composed document or message.

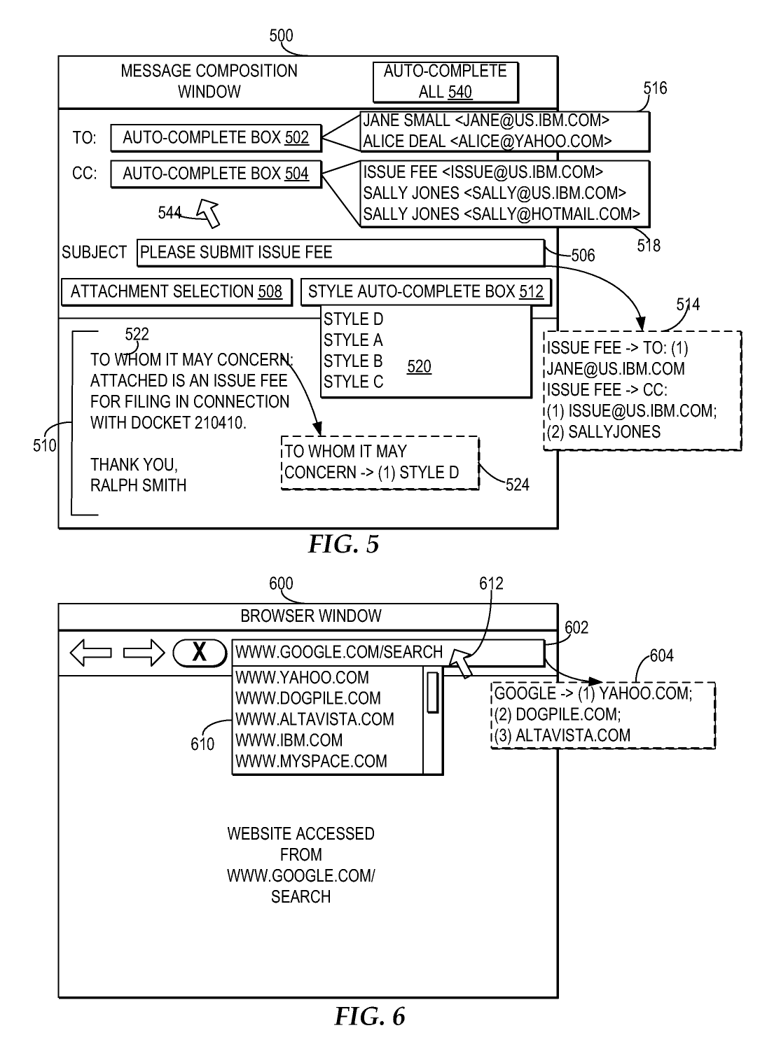

With reference now to FIG. 5, an illustrative diagram depicts a user interface in which a list of selectable addresses for an auto-complete box is reordered based on the content of a message composition window including the auto-complete box. In the example, a message composition window 500 includes an auto-complete box 502 for entering one or more network addresses or identifiers for recipients of an electronic message. In addition, message composition window 500 includes a second auto-complete box 504 for entering one or more network addresses or identifier for recipients designated to receive a carbon-copy of an electronic message. It will be understood that additional or alternate auto-complete boxes for entering network addresses may be implemented within message composition window 500.

In addition, message composition window 500 includes a subject line. In one embodiment, the subject line may also include an auto-complete box 506 in which a user may select from a list of subject entries which may be compiled and ordered by auto-complete controller 300.

Further, message composition window 500 includes an attachment selection 508. A user may select to attach one or more documents to an electronic message. In one embodiment, attachments election 508 may also be an auto-complete box in which a user may select from a list of attachment entries which may be compiled and ordered by auto-complete controller 300.

Message composition window 500 includes a message body 510 and a style auto-complete box 512 for application to message body 510 or selected portions of message body 510. A user may select from a list of style entries ordered by auto-complete controller 300 based on the content of the electronic message composed within message composition window 500.

As to auto-complete boxes 502 and 504, auto-complete controller 300 detects that subject auto-complete box 506 includes the phrase “issue fee” and accesses an ordering rule illustrated at reference numeral 514 that specifies ordering of addresses when the subject line includes the phrase “issue fee”. In the example, the ordering rule illustrated at reference numeral 514 specifies prioritizing an address “jane@us.ibm.com” as the first address in the list of address entries for auto-complete box 502 and prioritizing the addresses “issue@us.ibm.com” and “sally jones” as the first addresses in the list of address entries for second auto-complete box 504. A list 516 associated with auto-complete box 502 illustrates the ordering of entries based on the ordering rule illustrated at reference numeral 514 and a list 518 associated with second auto-complete box 504 illustrates the ordering of entries based on the ordering rule illustrated at reference numeral 514. By prioritizing addresses based on the content of subject line 506, where a user typically addresses an electronic message with the particular subject line content to multiple users, the addresses of those multiple users are reordered to the top of the list of network addresses such that the user may quickly locate and select the network addresses for the multiple users.

It is important to note that lists of address entries may list a network address or may list an alias for a network address. For example, in the ordering rule illustrated at reference numeral 514, for the “CC:” entries, one of the address entries is listed as a network address “issue@us.ibm.com” and the other address entry is listed as an alias to a network address “sally jones”. As illustrated in list 518, an alias to a network address may be an alias to more than one network address. For example, “sally jones” is an alias to both the network addresses of “sally@us.ibm.com” and “sally@hotmail.com”. In addition, when address entries are listed for selection by a user, as illustrated in list 516 and list 518, the alias and the network address may both be listed for each address entry such that a user may quickly identify the addressee, whether by alias or network address, when looking through the list.

As to the style auto-complete box 512, a style list 520 includes style entries for selection for style auto-complete box 512 ordered as “style D”, “style A”, “style B”, and “style C”. In particular, auto-complete controller 300 detects that the content of the message within message body 510, as illustrated at reference numeral 522, includes the phrase “To whom it may concern”. The ordering rule illustrated at reference numeral 524 requires that for compositions including the phrase “To whom it may concern”, “style D” should have priority among the list of styles.

In addition, in the example, an auto-complete button 540 provides for a user to select, using a single input, to automatically select and fill in each auto-complete box within electronic composition window 300 with the first prioritized entry in each auto-complete box list. For example, within message composition window 300, a user selection of auto-complete button 540 would trigger automatically filling in auto-complete box 502 with the address “jane@us.ibm.com”, filling in second auto-complete box 504 with the address “issue@us.ibm.com″”, and filling in style auto-complete box 512 with “style D”.

In the example, a user may make selections through multiple types of input, including making a selection based on the position of a pointer 544 when an input is received. It will be understood that in addition to pointer based selections, other selections of boxes, buttons, and other portions of messaging window 500 may be implemented.

It is important to note that while the example of a message composition window is described with reference to an electronic mail message composition window, an additional or alternate embodiments, a message composition window may include an instant messaging composition window, a text messaging composition window, a video conference window, or any other type of window that facilitates user composition of an electronic message.

Referring now to FIG. 6, an illustrative diagram depicts a user interface in which a list of selectable websites for an auto-complete box is reordered based on the content of the current website being viewed in a browser window that includes the auto-complete box. In the example, a browser window 600 currently displays the website data accessed at a network address including the word “google” within an auto-complete website address box 602.

Auto-complete controller 300 detects the presence of the word “google” within the network address currently accessed within browser window 600 and access an ordering rule illustrated at reference numeral 604. The ordering rule illustrated at reference numeral 604 specifies that when the currently accessed website includes a network address including the word “google”, then a list of website entries for the filling in auto-complete website address box 602 should be prioritized with other search engines including “yahoo.com” first, “dogpile.com” second, and “altavista.com” third.

When a user selects to enter a new address in website address box 602, a list 610 is illustrated with selectable website address entries ordered by auto-complete controller 300 in view of the ordering rule illustrated at reference numeral 604 determined based on the content of browser window 600. In the example, the websites given priority based on the ordering rule illustrated at reference numeral 604 are listed as the first three entries in list 610. In addition, following the priority based rules are addresses listed according to a most recently accessed rule, including “www.ibm.com” and “www.myspace.com”. In particular, it is important to note that multiple rules may be used to order the entries included in list 610, including the ordering rule illustrated at reference numeral 604 and other non-content based ordering rules, such as a most recently accessed rule or a most often accessed rule.

In the example, a user selects to enter a new address in website address box 602 by selecting website address box 602 with a pointer 612, It will be understood that other types of inputs allow a user to select to enter a new address in website address box 602.

Referring now to FIG. 7, a high level logic flowchart depicts a process and program for selecting a list of selectable entries for an auto-complete box and reordering the list of selectable entries based on the content of a window including the auto-complete box. In the example, the process starts at block 700 and thereafter proceeds to block 702.

Block 702 illustrates a determination whether a trigger for an auto-complete box is detected, and the process passes to block 702. In one example, a trigger for an auto-complete box may occur when a user selects the auto-complete box. In another example, a trigger for an auto-complete box may occur when a user selects an auto-complete button, such as auto-complete button 540, to select to automatically complete each auto-complete box within a window with the first entry in a list of entries for that auto-complete box. In addition, other types of inputs may trigger an auto-complete box.

Block 704 depicts detecting the current content within a window including the triggered auto-complete box, and the process passes to block 706. The types of current content detected within a window may vary according to the type of window.

Block 706 illustrates compiling a selection of applicable rules, a selection of ordering rules, and a selection of output characteristic rules based on the detected current content. Next, block 708 depicts compiling a list of selectable entries for the type of auto-complete box based on the selection of applicable rules. Thereafter, block 710 illustrates reordering the list of selectable entries based on the selection of ordering rules. Next, block 712 depicts adjusting the output characteristics of the list of selectable entries according the selection of output characteristic rules. Thereafter, block 714 displaying the reordering list with the adjusted output characteristics for selection from by the user, and the process ends.

With reference now to FIG. 8, a high level logic flowchart depicts a process and program for controlling the reordering a list of selectable entries determined for an auto-complete box. In the example, the process starts at block 800 and thereafter proceeds to block 802. As illustrated at reference numeral 802, the auto-complete controller detects a list of selectable entries determined for an auto-complete box. Next, block 804 depicts detecting the current content within a window including the auto-complete box. Thereafter, block 806 illustrates accessing a selection of ordering rules applicable to the auto-complete box based on the current content. Next, block 808 depicts reordering the list of selectable entries according to the selection of ordering rules as applied according to the current content. Therefore, block 810 illustrates passing the reordered list of selectable entries to the complete box controller that determined the original list of selectable entries, and the process ends.

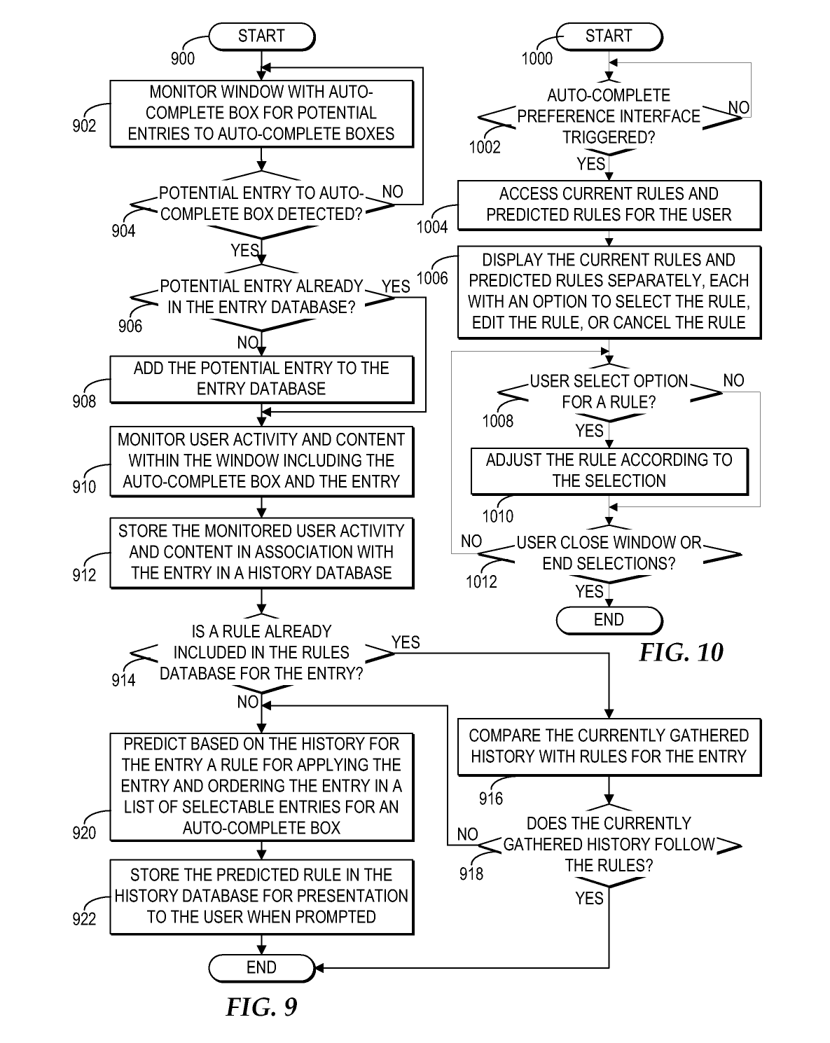

With reference now to FIG. 9, a high level logic flowchart depicts a process and program for monitoring potential entries for auto-complete boxes. In the example, the process starts at block 900 and thereafter proceeds to block 902. Block 902 illustrates monitoring windows for potential entries to auto-complete boxes. Next, block 904 depicts a determination whether a potential entry to an auto-complete box is detected. If a potential entry to an auto-complete box is detected, then the process passes to block 906. Block 906 illustrates a determination whether the potential entry is already in the entry database. If the potential entry is already in the entry database, then the process passes to block 910. If the potential entry is not already in the entry database, then the potential entry is added to the entry database, as illustrated at block 908, and the process passes to block 910.

Block 910 depicts monitoring the user activity and content within the window including the auto-complete box and the entry. Next, block 912 illustrates storing the monitored user activity and content in association with the entry within a history database. Thereafter, block 914 depicts a determination whether a rule is already included in the rules database for the entry. If a rule is already included in the rules database for the entry, then the process passes to block 916. Block 916 illustrates comparing the currently gathered history with the rule. Block 918 depicts a determination whether the currently gathered history follows the rule. If the currently gathered history does not follow the rule, then the process passes to block 920. If the currently gathered history does following the rule, then the process ends.

Returning to block 914, if there is not already a rule in the rules database for the entry, then the process passes to block 920. Block 920 depicts predicting, based on the history for the entry, a rule for applying the entry and ordering the entry in a list of selectable entries for an auto-complete box. Next, block 922 illustrates storing the predicted rule in the history database for presentation to the user when prompted, and the process ends.

Referring now to FIG. 10, a high level logic flowchart depicts a process and program for controlling a user interface for user preference selection of rules for an auto-complete controller. As illustrated, the process starts at block 1000 and thereafter proceeds to block 1002. Block 1002 depicts a determination whether an auto-complete user preference interface is triggered. If an auto-complete user preference interface is triggered, then the process passes to block 1004. In one example, an auto-complete user preference interface may be triggered any time a new rule is predicted and stored within the history database, as described with reference to FIG. 9. In another example, a user may enter an input to selectively open the auto-complete user preference interface.

Block 1004 depicts accessing the current rules and predicted rules for the user. Next, block 1006 illustrates displaying the current rules and predicted rules separately, each with an option to select the rule, to edit the rule, or to cancel the rule. Thereafter, block 1008 depicts a determination whether a user selects an option for a rule. If a user selects an option for a rule, then the process passes to block 1010. Block 1010 depicts adjusting the rule according to the selection, and the process passes to block 1012.

Returning to block 1008, if a user does not select an option for a rule, then the process passes to block 1012. Block 1012 depicts a determination whether a user selects to close the window or end selections of preferences. If the user does not select to close the window or end selections, the process returns to block 1008. If the user selects to close the window or end selections, then the process ends.

While the invention has been particularly shown and described with reference to a preferred embodiment, it will be understood by those skilled in the art that various changes in form and detail may be made therein without departing from the spirit and scope of the invention.

What is claimed is:

1. A method for ordering a list of selectable entries for an auto-complete box, comprising:
monitoring a window comprising an auto-complete box for at least one content element of said window;
responsive to detecting a user selection to fill in said auto-complete box, accessing a list of selectable entries for filling in said auto-complete box;
accessing at least one rule specifying ordering of said list of selectable entries based on said at least one content element; and
reordering said list of selectable entries for output in association with said auto-complete box with a most likely candidate listed first based on said at least one rule specifying ordering of said list of selectable entries based on said at least one content element.

2. The method according to claim 1, wherein monitoring a window comprising an auto-complete box for at least one content element of said window further comprises:
monitoring an electronic message composition window comprising an auto-complete box for filling in at least one network address for at least one addressee of an electronic message composed within said electronic message composition window for at least one content element of said electronic message.

3. The method according to claim 1, wherein monitoring a window comprising an auto-complete box for at least one content element of said window further comprises:
monitoring a browser window comprising an auto-complete box for selecting a next website address for access within said browser window for at least one content element of a current website displayed within said browser window.

4. The method according to claim 1, wherein monitoring a window comprising an auto-complete box for at least one content element of said window further comprises:
monitoring a composition window comprising an auto-complete box for selecting a style for at least one selection of a document composed within said window for at least one content element of said document composed within said composition window.

5. The method according to claim 1, wherein said at least one content element further comprises said window comprises a reply message, said window comprises a new message, and said window comprises a forwarded message.

6. The method according to claim 1, wherein said at least one content element further comprises a type of attachment to a document composed within said window.

7. The method according to claim 1, wherein said at least one content element further comprises an addressee specified for receiving an electronic message composed within said window.

8. The method according to claim 1, further comprising:
monitoring said window to detect at least one potential entry for said auto-complete box and a particular content element of said window;
predicting a particular rule for filling in a type of said auto-complete box with said at least one potential entry when said particular content element is detected; and
applying said particular rule to order said list of selectable entries for output in associated with said type of auto-complete box in a next window in which said particular content element is detected.

9. A system for ordering a list of selectable entries for an auto-complete box, comprising:
an auto-complete controller for monitoring a window comprising an auto-complete box for at least one content element of said window;
said auto-complete controller, responsive to detecting a user selection to fill in said auto-complete box, for accessing a list of selectable entries for filling in said auto-complete box;
said auto-complete controller for accessing at least one rule specifying ordering of said list of selectable entries based on said at least one content element; and
said auto-complete controller for reordering said list of selectable entries for output in association with said auto-complete box with a most likely candidate listed first based on said at least one rule specifying ordering of said list of selectable entries based on said at least one content element.

10. The system according to claim 9, wherein said auto-complete controller for monitoring a window comprising an auto-complete box for at least one content element of said window further comprises:
means for monitoring an electronic message composition window comprising an auto-complete box for filling in at least one network address for at least one addressee of an electronic message composed within said electronic message composition window for at least one content element of said electronic message.

11. The system according to claim 9, wherein said auto-complete controller for monitoring a window comprising an auto-complete box for at least one content element of said window further comprises:
means for monitoring a browser window comprising an auto-complete box for selecting a next website address for access within said browser window for at least one content element of a current website displayed within said browser window.

12. The system according to claim 9, wherein said auto-complete controller for monitoring a window comprising an auto-complete box for at least one content element of said window further comprises:
means for monitoring a composition window comprising an auto-complete box for selecting a style for at least one selection of a document composed within said window for at least one content element of said document composed within said composition window.

13. The system according to claim 9, wherein said at least one content element further comprises said window comprises a reply message, said window comprises a new message, and said window comprises a forwarded message.

14. The system according to claim 9, wherein said at least one content element further comprises a type of attachment to a document composed within said window.

15. The system according to claim 9, wherein said at least one content element further comprises an addressee specified for receiving an electronic message composed within said window.

16. The system according to claim 9, said auto-complete controller further comprising:
means for monitoring said window to detect at least one potential entry for said auto-complete box and a particular content element of said window;
means for predicting a particular rule for filling in a type of said auto-complete box with said at least one potential entry when said particular content element is detected; and
means for applying said particular rule to order said list of selectable entries for output in associated with said type of auto-complete box in a next window in which said particular content element is detected.

17. A program for ordering a list of selectable entries for an auto-complete box, said program embodied in a computer-readable medium, said program comprising computer-executable instructions which cause a computer to perform the steps of:
monitoring a window comprising an auto-complete box for at least one content element of said window;
responsive to detecting a user selection to fill in said auto-complete box, accessing a list of selectable entries for filling in said auto-complete box;
accessing at least one rule specifying ordering of said list of selectable entries based on said at least one content element; and
reordering said list of selectable entries for output in association with said auto-complete box with a most likely candidate listed first based on said at least one rule specifying ordering of said list of selectable entries based on said at least one content element.

18. The program according to claim 17, wherein said step of monitoring a window comprising an auto-complete box for at least one content element of said window further comprises the step of:
monitoring an electronic message composition window comprising an auto-complete box for filling in at least one network address for at least one addressee of an electronic message composed within said electronic message composition window for at least one content element of said electronic message.

19. The program according to claim 17, wherein said step of monitoring a window comprising an auto-complete box for at least one content element of said window further comprises the step of:
monitoring a browser window comprising an auto-complete box for selecting a next website address for access within said browser window for at least one content element of a current website displayed within said browser window.

20. The program according to claim 17, further comprising the steps of:
monitoring said window to detect at least one potential entry for said auto-complete box and a particular content element of said window;
predicting a particular rule for filling in a type of said auto-complete box with said at least one potential entry when said particular content element is detected; and
applying said particular rule to order said list of selectable entries for output in associated with said type of auto-complete box in a next window in which said particular content element is detected.
